(19) United States
(12) Patent Application Publication
(10) Pub. No.: US 2016/0216382 A1
(43) Pub. Date: Jul. 28, 2016

(54) A RADIATION DETECTOR AND A METHOD THEREOF

(71) Applicant: TELEDYNE DALSA B.V., Eindhoven (NL)

(72) Inventor: Rudolph Maria SNOEREN, Veldhoven (NL)

(73) Assignee: TELEDYNE DALSA B.V., Eindhoven (NL)

(21) Appl. No.: 14/913,956

(22) PCT Filed: Aug. 26, 2013
(86) PCT No.: PCT/EP2013/067606

§ 371 Date: Feb. 23, 2016

(51) Int. Cl. G01T 1/20

(52) U.S. Cl. CPC G01T 1/2002; G01T 1/2018

(57) ABSTRACT

A radiation detector (10; 11; 12) used to detect incident radiation (RR) received at a first side (S1) of the radiation detector (10; 11; 12). The radiation detector (10; 11; 12) includes a scintillator (15) to convert the incident radiation (RR) into converted radiation (CR), a photosensor (20) arranged at a second side (S2) of the radiation detector (10) opposite to the first side (S1) to receive the converted radiation (CR) from the scintillator (15) and an interference optical filter (25) arranged between the scintillator (15) and the photosensor (20). Areas of the scintillator (15) on which the incident radiation (RR) impinges are intended to be imaged onto corresponding areas of the photosensor (20). The interference optical filter (25) is constructed to attenuate a portion of the converted radiation (CR) resulting from the incident radiation (RR) and impinging on a particular one (A1) of the areas of the scintillator (15) which is received via direct transmission through the interference optical filter (25) by another one (A3) of the areas of the photosensor (20) different from the one (A2) corresponding to the particular one (A1) of the areas of the scintillator (15). By using the interference optical filter (25), lateral optical crosstalk caused by the portion of converted radiation (CR) which laterally spread from the particular area (A1) of the scintillator (15) is reduced.

### FIELD OF THE INVENTION

The invention relates to a radiation detector and to a method of manufacturing the radiation detector and a method of detecting incident radiation. The invention further relates to a flat panel radiation detector which includes said radiation detector and to a radiological instrument which includes any of said radiation detector or flat panel radiation detector.

### BACKGROUND ART

Radiation detectors are devices capable of detecting incident radiation. In medicine, radiation detectors for X-ray images have large applications for diagnosis of a patient's condition. The radiation detectors for X-ray images are typically integrated in radiological instruments that utilize computer-processed X-ray images to produce images of specific areas of a patient's body. These images may be planar images, panoramic images or so-called tomographic images. Planar images are typically obtained by flat panel radiation detectors. Panoramic images may be obtained by a sequence of planar images taken one after another. Tomographic images may instead be obtained by a three-dimensional reconstruction of the specific areas of the patient's body. The radiological instruments may be intra-oral radiologic dental imagers, dental imagers, computed tomography scanners (CT-scanner), computed axial tomography scanners (CAT-scanners), mobile C-arm, etc. The radiation detectors for X-ray images usually consist of a radiation converter element (e.g. a scintillator) that absorbs and converts the incident radiation (i.e. X-rays) into converted radiation with longer wavelength (e.g. photons). The converted radiation with longer wavelength reaches a photo sensitive element, e.g. a CMOS photosensor, a CCD image sensor, etc. The photo sensitive element may be coupled to an electronic system that generates electrical signals corresponding to a radiation pattern of the incident radiation absorbed by the radiation converter element. Data embodied in such electrical signals may be shown in a visual display or sent to a computer for further analysis of the radiation pattern.

The converted radiation is isotropically generated in the radiation converter element. As a consequence the converted radiation originated at one originating area of the radiation converter element in response to the incident radiation may be transmitted through the radiation converter element to an area of the photosensor far away from the originating area of the radiation converter element. This results in an undesired effect which is sometimes called in the art crosstalk or optical light spreading and may result in blurred X-ray images or X-ray images with less spatial resolution. Several solutions exist to prevent or limit crosstalk in radiation detectors. For example U.S. Pat. No. 6,452,186 B1 discloses a radiation detector for X-ray images that consists of a plurality of scintillator elements, a plurality of corresponding photosensitive elements underneath the scintillator elements and an intermediate layer in between. The scintillator elements are separated by each other by absorber plates to prevent direct lateral optical crosstalk of light quanta generated in the scintillator elements. The intermediate layer is constructed such to attenuate the light quanta generated in an originating scintillator element and travelling through multiple reflections in the intermediate layer from a photosensitive element corresponding to the originating scintillator element to neighbouring photosensitive elements.

US2012/0256095 discloses a radiation detector which consists of a sensor panel, a scintillator and two reflector layers placed on an opposite side of the sensor panel. The scintillator converts the incident radiation penetrating through the sensor panel to light and the light is detected by a photosensor in the sensor panel. The two reflector layers are constructed to specularly reflect light with a wavelength range lower than a desired wavelength threshold and to retro-reflect light with a wavelength range larger than the desired wavelength threshold. The desired wavelength threshold corresponds to an upper wavelength range of the spectral emission curve of the used scintillator. Since long-wavelength components of light generated in an originating area of the scintillator near the irradiated side tend to be transmitted through the scintillator with a small amount of refraction, the long-wavelength components of light may be typically transmitted at areas of the two reflector layers far away from the originating area of the scintillator near the irradiated side. The long-wavelength components of light are thus retro reflected by the reflector layers to bounce the long-wavelength components of the light back to the originating area of the scintillator. On the contrary, since short-wavelength components of the light generated in an area of the scintillator near the irradiated side tend to be more refrangible through the scintillator, the short-wavelength components of light may be typically transmitted through the scintillator at areas of the two reflector layers close to the corresponding originating area of the scintillator near the irradiated side. The short-wavelength components of light are thus specularly reflected by the two reflector layers to limit the lateral spreading of the short-wavelength components through the scintillator.

A problem with the solution disclosed in U.S. Pat. No. 6,452,186 B1 is that direct lateral optical crosstalk is reduced by the absorber plates between the scintillator elements, and the light quanta spreading through multiple reflections in the intermediate layer is reduced by a particular construction of the intermediate layer with substances which absorb electromagnetic radiations. Notably two distinct features are needed in

U.S. Pat. No. 6,452,186 B1 to limit the crosstalk through the scintillator, the absorber plates and the particular construction of the intermediate layer. As a consequence cost and complexity involved to manufacture the radiation detector disclosed in U.S. Pat. No. 6,452,186 B1 may be increased.

A problem with the solution proposed in US2012/0256095 is that the converted light in the scintillator needs to travel to the two reflector layers and back to the sensor panel to be detected by the photosensor in the sensor panel. The converted light needs to travel two times the thickness of the scintillator before impinging on the photosensor in the sensor panel, thereby decreasing the overall conversion efficiency of the radiation detector. Another problem with the solution proposed in US2012/0256095 is that the lateral optical crosstalk caused by the short-wavelength components of the converted light may be only partially reduced by the two reflector layers. In fact since the short-wavelength components of the converted light are specularly reflected by the two reflected layers, there will always be a certain amount of lateral optical crosstalk caused by the short-wavelength components of the converted light.

### SUMMARY OF THE INVENTION

One of the objects of the invention is to at least alleviate the problems of existing radiation detectors which are used to make radiographic images with reduced crosstalk. In particular one of the objects of the invention is to reduce the crosstalk generated within a radiation converter element of the radiation detector which converts incident radiations in the X-ray or gamma-ray range into converted radiation with higher wavelength than the X-ray or gamma-ray range. The converted radiation may be in an optical wavelength range. The crosstalk is caused by an isotropic scattering of the converted radiation which laterally spreads in the radiation converter element.

According to the invention this object is achieved by a radiation detector used to detect incident radiation at a first side of the radiation detector. The radiation detector includes a scintillator used to convert the incident radiation into converted radiation, a photosensor arranged at a second side of the radiation detector opposite to the first side receives the converted radiation from the scintillator, and an interference optical filter arranged between the scintillator and the photosensor. Areas of the scintillator on which the incident radiation impinges are intended to be imaged onto corresponding areas of the photosensor. The interference optical filter is constructed to attenuate a portion of the converted radiation resulting from the incident radiation which impinges on a particular one of the areas of the scintillator. The portion of the converted radiation attenuated by the interference optical filter is received through transmission through the interference optical filter by another one of the areas of the photosensor different from the one corresponding to the particular one of the areas of the scintillator.

By using the interference optical filter, the crosstalk in the radiation detector generated inside the scintillator by isotropic scattering of the converted radiation is reduced. The interference optical filter used in said radiation detector improves a so called detective quantum efficiency (DQE) of the radiation detector. The interference optical filter used in said radiation detector ensures that noise contribution caused by the laterally spread converted radiation which is received by an output area of the photosensor distant from an input originating area of the scintillator is at least attenuated. In this way blur and noise in radiographic images obtained by using the radiation detector according to the invention is reduced.

In an embodiment according to the invention, the interference optical filter may be constructed to transmit a portion of the converted radiation within a desired wavelength range to the photosensor and to reflect or absorb the converted radiation outside the desired wavelength range. The desired wavelength range may correspond to a combination of a specific emission wavelength band of the scintillator with which the converted radiation generated in the scintillator is emitted by the scintillator and a specific sensitivity wavelength band of the photosensor with which the photosensor may receive the converted radiation from the scintillator with the specific sensitivity. In this way a radiation detector with a reduced lateral optical crosstalk in the desired wavelength may be provided.

In another embodiment, the interference optical filter is constructed to increasingly attenuate a portion of the converted radiation in function of an increasing angle of incidence of the converted radiation with the interference optical filter. Since the converted radiation impinging on the interference optical filter with large angle of incidence causes a larger spread than the converted radiation impinging on the interference optical filter with small angle of incidence, attenuation by the interference optical filter of the portion of the converted radiation with larger angles of incidence with the interference filter improves further the lateral optical crosstalk and thus also the detective quantum efficiency.

In another embodiment according to the invention, the radiation detector further includes a reflector arranged at the first side of the radiation detector. The reflector is transparent to the incident radiation and may be constructed to reflect back to the scintillator a portion of the converted radiation directed towards the first side of the radiation detector. The reflector may be used to reflect back to the scintillator primary or secondary converted radiation. The primary converted radiation is a portion of the converted radiation which is generated in the scintillator and directly directed towards the first side of the radiation detector. The secondary converted radiation is a portion of the converted radiation which is generated in the scintillator directly directed towards the photosensor, reflected by the interference optical filter and impinging on the reflector. By using the reflector, a conversion efficiency of the radiation detector may be improved because the portion of the converted radiation which is directed towards the opposite side of the photosensor side may be recovered by one or multiple reflections in the reflector. The reflector may further ensure that any of the primary and/or secondary converted radiation may be reflected back to the area of the photosensor corresponding to the particular area of the scintillator wherein the converted radiation is generated. Alternatively the reflector may be constructed as the interference optical filter, i.e. to increasingly attenuate a portion of the primary or secondary converted radiation in function of an increasing angle of incidence of the portion of the primary or secondary converted radiation with the reflector. As a consequence the reflector may further improve the lateral optical crosstalk in the radiation detector.

According to another aspect of the invention there is provided a method of manufacturing a radiation detector which is used to detect incident radiation at a first side of the radiation detector, the method comprising the steps of:

constructing an interference optical filter,

coupling the interference optical filter to a photosensor at a second side of the radiation detector opposite to the first side, and

growing a scintillator layer being coupled to the interference optical filter, wherein the scintillator layer converts the incident radiation received at the first side into converted radiation, wherein the photosensor receives the converted radiation from the scintillator layer, wherein areas of the scintillator layer on which the incident radiation impinges are intended to be imaged onto corresponding areas of the photosensor and wherein the interference optical filter attenuates a portion of the converted radiation resulting from the incident radiation impinging on a particular one of the areas of the scintillator and received via direct transmission through the interference optical filter by another one of the areas of the photosensor different from the one corresponding to the particular one of the areas of the scintillator.

Such a method leads to a radiation detector which has the earlier mentioned advantages.

According to a further aspect of the invention there is provided a method of detecting incident radiation received at a first side of a radiation detector, the method comprising:

converting the incident radiation into converted radiation with a scintillator,

receiving the converted radiation from the scintillator by a photosensor at a second side of the radiation detector opposite to the first side, wherein areas of the scintillator on which the incident radiation impinges are intended to be imaged onto corresponding areas of the photosensor, and

attenuating with an interference optical filter between the scintillator and the photosensor a portion of the converted radiation resulting from the incident radiation impinging on a particular one of the areas of the scintillator and received through direct transmission through the interference optical filter by another one of the areas of the photosensor different from the one corresponding to the particular one of the areas of the scintillator.

### BRIEF DESCRIPTION OF THE DRAWINGS

These and other aspects of the invention are apparent from and will be elucidated with reference to the embodiments described hereinafter. In the drawings,

FIG. 1 shows a cross section of an example of a radiation detector according to the invention,

FIG. 2 shows a transmission spectrum curve for an optical interference filter used in a radiation detector according to the invention,

FIG. 3 shows a cross section of another example of a radiation detector according to the invention, and

FIG. 4 shows a cross section of a further example of a radiation detector according to the invention,

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

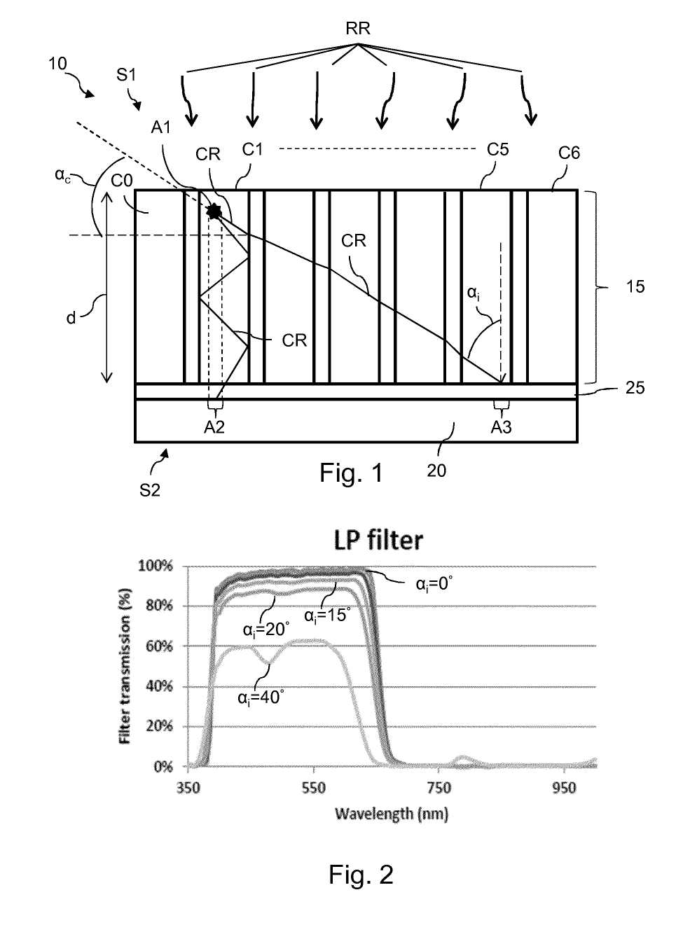

FIG. 1 shows a cross section of a radiation detector 10 according to the invention. The radiation detector 10 of FIG. 1 detects incident radiation RR at a first side S1 of the radiation detector 10. The radiation detector 10 of FIG. 1 is a flat panel radiation detector. The radiation detector 10 may have a different shape than the flat shape shown in FIG. 1. the radiation detector 10 may have for example a non-flat surface, for example a concave or convex surface. The incident radiation RR may be X-ray radiation from an X-ray radiation source which penetrates a body of a patient before impinging on the radiation detector 10 at the first side S1. The incident radiation

RR which impinges on the radiation detector 10 at the first side S1 is detected by the radiation detector 10 and converted into a radiographic image that may be used to diagnose a condition of the patient. The radiation detector 10 includes a scintillator 15 to convert the incident radiation RR (e.g. X-ray radiation) into converted radiation CR (e.g. photon) and a photosensor 20 arranged at a second side S2 of the radiation detector 10 opposite to the first side S1 to receive the converted radiation CR from the scintillator 15. The radiation detector 10 further includes an interference optical filter 25 arranged between the scintillator 15 and the photosensor 20. The photosensor 20 receives the converted radiation CR and translates the converted radiation CR into an image that may be further processed or displayed. The converted radiation CR has typically a longer wavelength range than the incident radiation RR. The longer wavelength range of the converted radiation CR may correspond to the wavelength range that can be detected by the photosensor 20. The scintillator 15 may be a CsI:Tl (Caesium Iodide doped with thallium) scintillator. In fact CsI:Tl scintillators are highly efficient radiation converter elements in the X-ray range. CsI:Tl scintillators are capable of absorbing radiation in the X-ray range with high efficiency, partly preventing that the incident radiation RR hits the photosensor, i.e. in other words CsI:Tl scintillators have a so called high X-ray stopping power. Further to that CsI:Tl scintillators convert the incident radiation RR into the converted radiation CR with high efficiency, i.e. CsI:Tl scintillators have a high conversion efficiency.

Areas of the scintillator 15 on which the incident radiation RR impinges are intended to be imaged onto corresponding areas of the photosensor 20. For example and as shown in FIG. 1, the incident radiation RR impinges on a particular area A1 of the scintillator 15, drawn in FIG. 1 as a black spot near a surface of the scintillator 15 on which the incident radiation RR impinges. At the particular area A1 of the scintillator 15 the incident radiation RR is converted into converted radiation CR. The converted radiation CR scatters from the particular area A1 of the scintillator 15 in all directions inside the scintillator 15. However the converted radiation CR converted at the particular area A1 of the scintillator 15 is intended to be imaged onto a corresponding area A2 of the photosensor 20. In the embodiment shown in FIG. 1, the corresponding area A2 is displaced with respect to the area A1 in a direction of the incident radiation RR. Preferably, the particular area A1 and the corresponding area A2 are arranged in parallel with a flat or almost flat surface of the scintillator 15 on which the incident radiation RR impinges and are displaced in a direction perpendicular to said surface. In other words when all the converted radiation CR at the particular area A1 of the scintillator 15 is received by the photosensor 20 at the corresponding area A2 directly below the particular area A1 in a direction defined by the incident radiation RR, radiographic images obtained with the radiation detector 10 have an intended optimal spatial resolution. In fact in this intended situation the radiation detector 10 has an optimal Detective Quantum Efficiency (DQE). The Detective Quantum Efficiency is in the art a widely accepted Figure Of Merit (FOM) for radiation detectors. The Detective Quantum Efficiency represents a noise figure measure of the radiation detector 10, i.e. a ratio between the signal to noise ratio at an input (e.g. wherein the incident radiation RR impinges on the scintillator 15) of the radiation detector 10 and the signal to noise ratio at an output (e.g. wherein the converted radiation CR is received by the photosensor 20) of the radiation detector 10. The DQE may be expressed as a function of the frequency, notably as the spatial frequency. If the converted radiation CR at the particular area A1 of the scintillator 15 is received by another area A3 of the areas of the photosensor 20 different from said corresponding area A2, the DQE at the another area A3 of the photosensor 20 will be lower with respect to the DQE calculated at said corresponding area A2 of the photosensor 20. The DQE versus the spatial frequency reduces as a function of the distance between the area A3 of the photosensor 20 and the area A2 of the photosensor 20 corresponding to the particular area A1 of the scintillator 15.

The interference optical filter 25 shown in FIG. 1 is constructed to attenuate a portion of the converted radiation CR resulting from the incident radiation RR that impinges on a particular area A1 of the scintillator 15 and which is received through direct transmission through the interference optical filter 25 by another area A3 of the photosensor 20 different from said area A2 of the photosensor 20 corresponding to the particular area A1 of the scintillator 15. By using the interference optical filter 25 having the above mentioned properties the Detective Quantum Efficiency of the radiation detector 10 may be improved. Lateral optical crosstalk caused by the portion of the converted radiation CR which laterally spread from the particular area A1 of the scintillator 15 is thus also reduced.

By way of comparison the solution proposed in the prior art document U.S. Pat. No. 6,452,186 B1 requires absorber plates between the scintillator elements and a specific construction of the intermediate layer to limit light quanta spreading through multiple reflections in the intermediate layer while the present invention reduces lateral optical crosstalk by using exclusively the interference optical filter 25. The scintillator 15 used in the radiation detector 10 of the present invention may be any type of scintillator and is not limited to a plurality of scintillator elements as instead used by the solution proposed in the prior art document U.S. Pat. No. 6,452,186 B1 wherein a space between the scintillator elements is filled with an absorber material to prevent the direct lateral optical crosstalk.

Compared to US2012/0256095 the present invention discloses a simpler radiation detector 10. In the present invention the converted radiation CR which is converted after impinging on the scintillator 15 at the first side S1 of the scintillator 15 opposite to the second side S2 wherein the photosensor is arranged, does not need to travel twice a thickness d of the scintillator 15 before impinging on the photosensor 15. The solution proposed in US2012/0256095 requires that the converted radiation which is spreading away from an originating area in the scintillator travels twice a distance equivalent to the thickness of the scintillator. The radiation detector 10 disclosed in the present invention thus may have a better conversion efficiency because less converted radiation CR in the scintillator 15 may be lost before impinging on the photosensor 20 in the travel from the originating area in the scintillator to the photosensor 20. The solution proposed in US2012/0256095 additionally requires two reflector layers operating at different wavelength ranges in order to let the converted radiation which is spreading away from the originating area of the scintillator to be reflected back to the originating area of the scintillator. In the present invention it is sufficient that the interference optical filter 25 is constructed to attenuate a portion of the converted radiation CR originating at the particular area A1 of the scintillator 15, travelling inside the scintillator 15, impinging on the interference optical filter 25 and received by the photosensor 20 via direct transmission through the interference optical layer 25 at an area A3 of the photosensor 20 different from the area A2 of the photosensor 20 which corresponds to the particular area A1 of the scintillator 15.

In another embodiment according to the invention the interference optical filter 25 may be further constructed to transmit a portion of the converted radiation CR within a desired wavelength range to the photosensor 20 and to reflect or absorb the converted radiation CR outside the desired wavelength range. The scintillator 15 may have a specific emission wavelength band, i.e. a wavelength range within which the converted radiation CR is emitted inside the scintillator 15. For example in the case of thallium doped Cesium Iodide scintillators, the specific emission wavelength band is in a range between 400 and 800 nm with a peak emission wavelength of 550 nm. The photosensor 20 may also have a specific sensitivity wavelength band, i.e. a wavelength range within which the photosensor 20 is able to receive the converted radiation CR with high sensitivity and convert the converted radiation CR into electrical signals. As a consequence, the desired wavelength range within which the interference optical filter 25 transmits a portion of the converted radiation CR to the photosensor 20 and outside which the interference optical filter 25 reflects or absorbs the converted radiation CR, may correspond to a product of the specific emission wavelength band of the scintillator 15 and the specific sensitivity wavelength band of the photosensor 20. For example, the desired wavelength range of the interference optical filter 25 may be in a range between 350 nm and 650 nm or in a range of wavelengths lower than 650 nm.

It should be noted that according to what is previously mentioned, the interference optical filter 25 transmits a portion of the converted radiation CR within the desired wavelength range in a percentage that is decreasingly a function of a distance between the area A3 on which the spread converted radiation CR impinges on the photosensor 20, and the area A2 of the photosensor 20 corresponding to the particular area A1 of the scintillator 15.

With reference to FIG. 1, the scintillator 15 is a columnar scintillator. In one embodiment the scintillator 15 may be a CsI:Tl columnar scintillator. Alternatively the scintillator 15 may be made of another compound or may be a non-columnar scintillator. For example the scintillator 15 may be made by growing cubic crystals of a suitable scintillator compound with an axis perpendicular to a substrate above which the cubic crystals are grown. Alternatively granular deposition may be used to fabricate the non-columnar scintillator.

With reference to FIG. 1 the columnar scintillator 15 consists of crystal columns C0 to C6 of average diameters as small as a few microns. When the crystal columns C0 to C6 of the columnar scintillator 15 are spatially separated such that the converted radiation CR is confined in the crystal columns C0 to C6, the columnar scintillator 15 is said to have a high spatial resolution, provided that the average diameter of the crystal columns C0 to C6 is as small as a few microns. In high spatial resolution columnar scintillators distance between the crystal columns C0 to C6 is negligible compared to the average diameter of the crystal columns C0 to C6. The distance between the crystal columns C0 to C6 may be more than 1000 times smaller than the average diameter of the crystal columns C0 to C6. Besides that, also a length of the crystal columns C0 to C6 (i.e. the thickness d of the columnar scintillator 15) affects the spatial resolution. As shown in FIG. 1 the crystal columns C0 to C6 of the columnar scintillator 15 may be act as wave guides for the converted radiation CR generated isotropically in the columnar scintillator 15. The crystal columns C0 to C6 act as wave guiding elements for the converted radiation CR in the columnar scintillator 15 in order to direct the converted radiation CR towards the photosensor 20. However, as shown in FIG. 1, the crystal columns C0 to C6 act as wave guiding elements only when the converted radiation CR hits a lateral boundary of the crystal columns C0 to C6 with an angle of incidence larger than a critical angle of incidence α_{c}. For a CsI columnar scintillator, the critical angle of incidence α_{c} at the lateral boundary of the crystal columns C0 to C6 is 34°. A portion of the converted radiation CR scattered in all directions from the particular area A1 of the columnar scintillator 15 and having an angle of incidence at the lateral boundary of the crystal column C1 larger than the critical angle of incidence α_{c}, will be wave guided through multiple reflections within the crystal column C1 towards the photosensor 20, provided that each one of the multiple reflections has also an angle of incidence with the lateral boundary larger than the critical angle of incidence α_{c}. A portion of the converted radiation CR scattered in all directions from the particular area A1 of the columnar scintillator 15 and having an angle of incidence with the lateral boundary of the crystal column C1 smaller than the critical angle of incidence α_{c}, will be spreading through multiple refractions across the crystal columns C1 to C5 towards the photosensor 20 at the area A3. The smaller the angle of incidence of the converted radiation CR with the lateral boundary of the crystal columns C0 to C6 is, the larger an angle of incidence αᵢ of the converted radiation CR refracted through the crystal columns C0 to C6 with the interference optical filter 25 is.

In another example according to the invention the interference optical filter 25 may be constructed to increasingly attenuate a portion of the converted radiation CR within the desired wavelength range in function of an increasing angle of incidence of the converted radiation CR with the interference optical filter 25 at said another one A3 of the areas of the photosensor 20. A larger angle of incidence αᵢ of the converted radiation CR with the interference optical filter 25 indicates a larger spread of the converted radiation CR with respect to the area A2 of the photosensor 10. When the interference optical filter 25 is constructed to increasingly attenuate a portion of the converted radiation CR in function of an increasing angle of incidence αᵢ with the interference optical filter 25, the lateral optical crosstalk of the converted radiation CR may be further reduced. The interference optical filter 25 may be thus constructed to attenuate in a lesser proportion the converted radiation CR with smaller angle of incidence αᵢ with the interference optical filter 25 in which case the converted radiation CR within the desired wavelength range may be received by the photosensor 20 in a way that a greater part of the transmission of the converted radiation CR towards the photosensor 20 may be confined around the corresponding area A2 of the photosensor 20, i.e. in this example within the crystal column C1 of the columnar scintillator 15.

In another embodiment according to the invention the interference optical filter 25 may be further constructed to reflect a portion of the converted radiation CR within the desired wavelength range in function of an increasing angle of incidence αᵢ of the converted radiation CR with the interference optical filter 25 at said another one A3 of the photosensor 20. In this way the converted radiation CR within the desired wavelength range and with a large angle of incidence αᵢ may be reflected back into the columnar scintillator 15. The reflected converted radiation CR may be available to be re-used by the columnar scintillator 15 as additional converted radiation CR and to be received by the photosensor 20 in the vicinity of the corresponding area A2.

FIG. 2 shows a transmission spectrum curve relative to the optical interference filter 25 which may be used in the radiation detector 10 shown in FIG. 1. The transmission spectrum curve shown in FIG. 2 is of a bandpass interference optical filter which transmits the converted radiation CR within a wavelength range between 350 nm and 650 nm. As shown in FIG. 2, within the passband wavelength range, i.e. between 350 nm and 650 nm, a transmission percentage of the interference optical filter 25 increases as much as the angle of incidence αᵢ of the converted radiation CR with the interference optical filter decreases. For example if the angle of incidence αᵢ of the converted radiation CR with the interference optical filter is equivalent to 40°, the transmission percentage of the converted radiation CR within the passband wavelengths range is between 50% and 60%. As a consequence, if the angle of incidence αᵢ of the converted radiation CR with the interference optical filter 25 is equivalent to 40°, 40% to 50% of the converted radiation CR may be reflected or absorbed by the interference optical filter 25. For angles of incidence αᵢ in a range between 0° to 20°, i.e. for smaller angle of incidence αᵢ, the interference optical filter 25 shown in FIG. 2 has, within the passband wavelengths range, an increased transmission percentage, i.e. in a range between 80% to 100%. As a consequence, if the angle of incidence αᵢ of the converted radiation CR with the interference optical filter 25 is in a range between to 0° to 20, 0% to 20% of the converted radiation CR may be reflected or absorbed by the interference optical filter 25. Outside the passband wavelength range, i.e. outside the wavelength range between 350 nm and 650 nm, the interference optical filter 25 whose transmission spectrum curve is shown in FIG. 2 ideally reflects or absorbs 100% of the converted radiation CR whatever the angle of incidence αᵢ of the converted radiation CR with the interference optical filter 25 is. If the interference optical filter 25 is constructed to reflect 100% of the converted radiation CR outside the passband, this converted radiation CR may be re-used by the columnar scintillator 15 and down-converted or up-converted again in the passband wavelength range. In this way the down-converted or up-converted converted radiation CR may be received by the photosensor 20 in proximity of the originating area A1 of the columnar scintillator 15, i.e. in proximity of the corresponding area A2 of the photosensor 20.

It should be noted that alternatively to the interference optical filter 25 with the transmission spectrum curve shown in FIG. 2, another interference optical filter 25 with a different transmission spectrum curve may be used. For example the interference optical filter 25 may be a low-pass interference optical filter with a cut-off wavelength of 650 nm. In the low-pass band, the low-pass interference optical filter may increasingly attenuate a portion of the converted radiation CR impinging on the low-pass interference optical filter in function of an increasing angle of incidence αᵢ of the portion of the converted radiation CR with the low-pass interference optical filter. Outside the low-pass band, i.e. above the cut-off wavelength, the low-pass interference optical filter may be designed to ideally reflect or absorb 100% of the portion converted radiation CR whatever the angle of incidence αᵢ of the portion of converted radiation CR with the low-pass interference optical filter is.

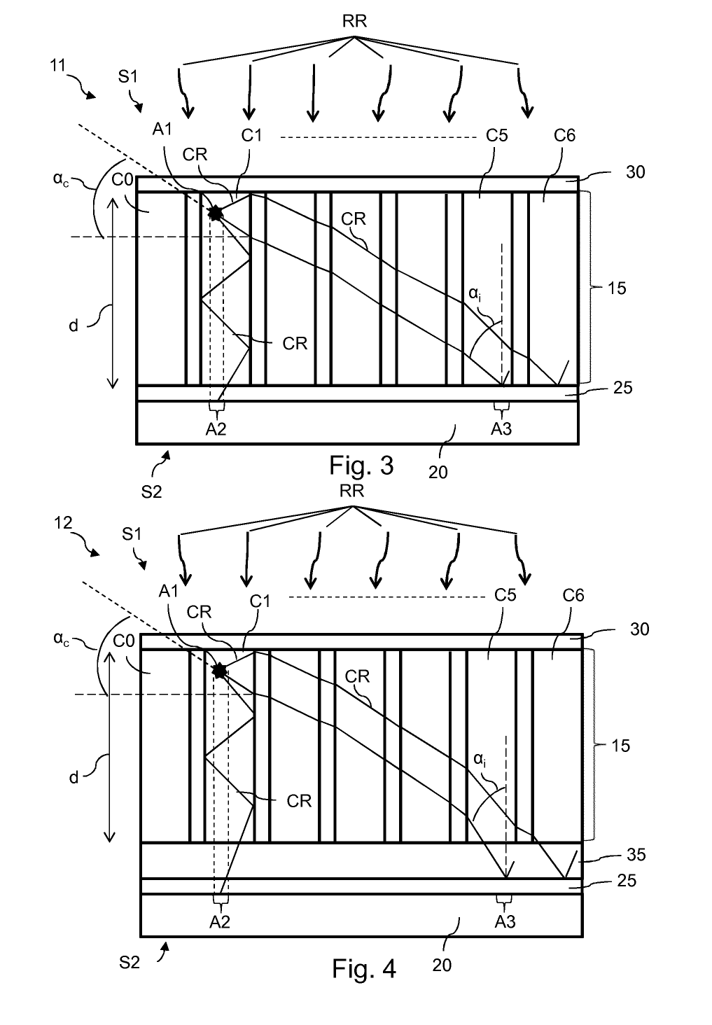

FIG. 3 shows a cross section of another example of a radiation detector 11 according to the invention. The radiation detector 11 shown in FIG. 3 is equivalent to the radiation detector 10 shown in FIG. 1 except that the radiation detector 11 further includes a reflector 30 arranged at the first side S1 of the radiation detector 11 which is transparent to the incident radiation RR. The reflector 30 may be constructed to reflect back to the columnar scintillator 15 a portion of the converted radiation CR directed towards the first side S1 of the radiation detector 11. The reflector 30 is used to reflect back to the columnar scintillator 15 a portion of the converted radiation CR which is not directly transmitted from the originating area A1 of the columnar scintillator 15 via direct transmission through the interference optical filter 25 to the photosensor 20. This portion of the converted radiation CR may for example be a primary converted radiation CR which is generated at an area A1 of the columnar scintillator 15 but it is directed towards the first side S1 of the radiation detector 11. Alternatively the portion of the converted radiation CR may for example be secondary converted radiation CR which may be generated at the area A1 of the columnar scintillator 15 directly directed towards the interference optical filter 25 and reflected by the interference optical filter 25 back to the columnar scintillator 15 towards the reflector 30. The reflector 30 may reflect the primary or secondary converted radiation CR back to the area A1 of the columnar scintillator 15 where the converted radiation CR is generated. In this last case the reflected primary or secondary converted radiation CR may be wave guided within the crystal columns C0 to C6 towards the photosensor 20. The reflector 30 may be a stack of multiple reflecting layers, wherein each one of the multiple reflecting layers in the stack may be designed to transmit the incident radiation RR (i.e. to be transparent to the incident radiation RR) and to selectively reflect the desired wavelength range of the converted radiation CR with an angle of incidence with the reflector 30 which improves further the lateral optical crosstalk. For example the reflector 30 may be constructed as the interference optical filter 25, i.e. to increasingly attenuate a portion of the primary or secondary converted radiation CR in function of an increasing angle of incidence of the portion of the primary or secondary converted radiation CR with the reflector 30. In this last case a surface of the columnar scintillator 15 on which the reflector 30 may be placed should be polished to yield an optical flat surface.

FIG. 4 shows a cross section of another example of a radiation detector 12. The radiation detector 12 shown in FIG. 4 is equivalent to the radiation detector 10 shown in FIG. 3 except that the radiation detector 12 further includes an optical layer 35 arranged between the columnar scintillator 15 and the interference optical filter 25 to protect the photosensor 20 against the incident radiation RR. Alternatively the optical layer 35 may be arranged between the interference optical filter 25 and the photosensor 20, which is an option not shown in FIG. 4. The optical layer 35 optically couples the interference optical filter 25 with the columnar scintillator 15 or the interference optical filter 25 with the photosensor 20. The optical layer 35 may be a fiber optical plate between the photosensor 20 and the columnar scintillator 15. The radiation detector 12 may receive a high dose of incident radiation RR during its lifetime and it should withstand that high dose of incident radiation RR. The optical layer 15 may be used to protect the photosensor 20 from the portion of the high dose of incident radiation RR that is not stopped by the columnar scintillator 15. Further to that the optical layer 35 may prevent the incident radiation RR to interact with a substrate of the photosensor 20, e.g. a silicon substrate, thereby generating charge carriers, e.g. electrons or holes, which would produce an undesired blurred or scattered response of the photosensor 20.

The interference optical filter 25 so far described may be constructed as a stack of at least two layers having alternatingly a relatively higher refraction index and a relatively lower refraction index. The at least two layers in the stack may be at least a caesium iodide layer and a zinc sulphide layer. The caesium iodide layer may be a first layer of the stack of the at least two layers with the relatively higher refraction index. A second layer of the stack interfacing the caesium iodide layer (e.g. a zinc sulphide layer) may be a layer of the stack with the relatively lower refraction index. The interference optical filter 25 may be constructed with more than two layers of any suitable type having alternatingly a relatively higher refraction index and a relatively lower refraction index.

The interference optical filter 25 may encompass a large stack of so called Fabry-Perot interference cavities with a bandpass property. It is a known property of these so called Fabry-Perot interference cavities that for large incident angles of the converted radiation CR with a surface, a cut-off wavelength of the interference optical filter 25 shifts toward lower wavelengths, thereby reflecting the converted radiation CR for these incident angles beyond this cut-off wavelength. Absorption of the interference optical filter 25 at large incident angles may be enhanced by the introduction of a metal layer in the stack of the at least two layers having alternatingly a high refraction index and a lower refraction index. The interference optical filter 25 may be constructed with the stack of at least two layers with or without an intermediate metal layer such that net transmission of the converted radiation CR generated in the columnar scintillator 15 may be sufficiently large in order not to reduce sensitivity of the radiation detector 10, 11 or 12 to an unacceptable value, i.e. for example to a value less than 90%.

The radiation detector 10, 11 or 12 so far described through FIGS. 1, 3 and 4 may be integrated in a flat panel radiation detector to detect for example X-rays. A radiological instrument such as for example an intra-oral radiologic dental imager or a dental imager or a computed tomography scanner (CT-scanner) or a computed axial tomography scanners (CAT-scanners) or a mobile C-arm, etc., may include the radiation detector 10, 11 or 12 described through FIGS. 1, 3 and 4 or the flat panel radiation detector which integrates such radiation detector 10, 11 or 12.

The radiation detector 10 presented in FIG. 1 and used to detect incident radiation RR at a first side S1 of the radiation detector 10 may be manufactured with a method including the following steps. In a first step an interference optical filter 25 is constructed. In a second step the interference optical filter 25 is coupled to a photosensor 20. The photosensor 20 is arranged at a second side S2 of the radiation detector 10 opposite to the first side S1. In a third step a scintillator layer 15 is grown to convert the incident radiation RR received at the first side S1 into converted radiation CR. In a fourth step the scintillator layer 15 is coupled to the interference optical filter 25. The photosensor 20 receives the converted radiation CR from the scintillator layer 15. Areas of the scintillator layer 15 on which the incident radiation RR impinges are intended to be imaged onto corresponding areas of the photosensor 20. The interference optical filter 25 attenuates a portion of the converted radiation CR resulting from the incident radiation RR impinging on a particular one A1 of the areas of the scintillator 15 and received via direct transmission through the interference optical filter 25 by another one A3 of the areas of the photosensor 20 different from the one A2 corresponding to the particular one A1 of the areas of the scintillator layer 15.

The interference optical filter 25 may be directly coupled to the photosensor 20, e.g. attached to the photosensor 20 with a bonding substance transparent to the converted radiation CR. Alternatively the interference optical filter 25 may be coupled to the photosensor 20 via an optical layer 35 attached to the photosensor 20, e.g. a fiber optical plate attached to the photosensor 20 with glue transparent to the converted radiation CR. In any of these two last alternative cases the scintillator layer 15 may be grown directly on the interference optical filter 25. Alternatively in case the interference optical filter 25 is directly coupled to the photosensor 20, an optical layer 35 may be provided directly on top of the interference optical filter 25. In this latter case the scintillator layer 15 may be grown directly on top of the optical layer 35.

Additionally, the method of manufacturing the radiation detector 11 may include after the step of growing the scintillator layer 15, the step of: providing a reflector 30 arranged at the first side S1 of the radiation detector 11. The reflector 30 is transparent to the incident radiation RR and constructed to reflect back to the scintillator 15 a portion of the converted radiation CR directed towards the first side S1 of the radiation detector 11. The reflector 30 may be constructed in a similar way as the interference optical filter 25, i.e. to increasingly attenuate a portion of the converted radiation CR in function of an increasing angle of incidence of the portion of the converted radiation CR with the reflector 30. In this way the portion of the converted radiation CR impinging on the reflector 30 with a large angle of incidence may be attenuated and not reflected back to the scintillator layer 15. Alternatively the reflector 30 may reflect the portion of the converted radiation CR impinging on the reflector 30 with a large angle of incidence such that the this portion of the converted radiation CR may be reflected back to the area A2 of the photosensor 20 corresponding to the particular area A1 of the scintillator layer 15 wherein the converted radiation CR is generated.

The radiation detector 10 presented in FIG. 1 may be used to detect incident radiation RR at a first side S1 of the radiation detector 10 with a method of detecting the incident radiation RR including the following steps. In a first step the incident radiation RR is converted into converted radiation CR with a scintillator 15. In a second step a photosensor 20 receives the converted radiation CR from the scintillator 15 at a second side S2 of the radiation detector 10 opposite to the first side S1, wherein areas of the scintillator 15 on which the incident radiation RR impinges are intended to be imaged onto corresponding areas of the photosensor 20. In a third step an interference optical filter 25 between the scintillator 15 and the photosensor 20 attenuates a portion of the converted radiation CR resulting from the incident radiation RR which impinges on a particular one A1 of the areas of the scintillator 15 and which is received via direct transmission through the interference optical filter 25 by another one A3 of the areas of the photosensor 20 different from the one A2 corresponding to the particular one A1 of the areas of the scintillator 15.

Said method of detecting the incident radiation RR may additionally include the step of reflecting back to the scintillator 15 with a reflector 30 at the first side S1 of the radiation detector 11 and transparent to the incident radiation RR, a portion of the converted radiation CR directed towards the first side S1 of the radiation detector 11. This portion of converted radiation CR impinging on the reflector 30 at a side of the scintillator 15 may be primary and/or secondary converted radiation CR, i.e. converted radiation CR directly impinging on the reflector 30 from an originating area Al of the scintillator wherein the converted radiation CR is generated and/or converted radiation CR impinging on the reflector 30 after one or multiple reflections between the reflector 30 and the optical interference filter 25.

It should be noted that the above-mentioned embodiments illustrate rather than limit the invention, and that those skilled in the art will be able to design many alternative embodiments. For example it should be note that the particular area A1 of the columnar scintillator 15, the corresponding area A2 of the photosensor 20 and the another one area A3 of the photosensor are merely illustrative example areas used to explain the effect reached by the solution provided in the present invention. This effect is clearly not limited to these specific areas but to any other areas or regions of the columnar scintillator 15 or the photosensor 20 with equivalent properties.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A radiation detector (10; 11; 12) for detecting incident radiation (RR) received at a first side (S1) of the radiation detector (10; 11; 12), the radiation detector (10; 11; 12) comprising:
a scintillator (15) for converting the incident radiation (RR) into converted radiation (CR),
a photosensor (20) arranged at a second side (S2) of the radiation detector (10) opposite to the first side (Si) for receiving the converted radiation (CR) from the scintillator (15), wherein areas of the scintillator (15) on which the incident radiation (RR) impinges are intended to be imaged onto corresponding areas of the photosensor (20), and
an interference optical filter (25) arranged between the scintillator (15) and the photosensor (20), wherein
the interference optical filter (25) is constructed for attenuating a portion of the converted radiation (CR) resulting from the incident radiation (RR) impinging on a particular one (A1) of the areas of the scintillator (15) and received via direct transmission through the interference optical filter (25) by another one (A3) of the areas of the photosensor (20) different from the one (A2) corresponding to the particular one (A1) of the areas of the scintillator (15).

2. The radiation detector (10; 11; 12) according to claim 1 wherein the interference optical filter (25) is further constructed for transmitting a portion of the converted radiation (CR) within a desired wavelength range to the photosensor (20) and for reflecting or absorbing the converted radiation (CR) outside the desired wavelength range.

3. The radiation detector (10; 11; 12) according to claim 2 wherein the interference optical filter (25) is further constructed for increasingly attenuating a portion of the converted radiation (CR) within the desired wavelength range in function of an increasing angle of incidence (αi) of the converted radiation (CR) with the interference optical filter (25) at said another one (A3) of the areas of the photosensor (20).

4. The radiation detector (10; 11; 12) according to claim 2 wherein the interference optical filter (25) is further constructed for increasingly reflecting a portion of the converted radiation (CR) within the desired wavelength range in function of an increasing angle of incidence (αi) of the converted radiation (CR) with the interference optical filter (25) at said another one (A3) of the areas of the photosensor (20).

5. The radiation detector (10; 11; 12) according to claim 1 wherein the interference optical filter (25) is a band-pass optical interference filter or a low-pass optical interference filter.

6. The radiation detector (11) according to claim 2 further comprising a reflector (30) arranged at the first side (S1) of the radiation detector (11) and being transparent to the incident radiation (RR), the reflector (30) being constructed for reflecting back to the scintillator (15) a portion of the converted radiation (CR) directed towards the first side (S1).

7. The radiation detector (11) according to claim 6 wherein the reflector (30) is further constructed to increasingly attenuate a portion of the converted radiation (CR) in function of an increasing angle of incidence of the portion of the converted radiation (CR) with the reflector (30).

8. The radiation detector (12) according to claim 1 further comprising an optical layer (35) arranged between the scintillator (15) and the interference optical filter (25) or between the interference optical filter (25) and the photosensor (20) for protecting the photosensor (20) against the incident radiation (RR).

9. The radiation detector (10; 11; 12) according to claim 5 wherein the interference optical filter (25) comprises a stack of at least two layers having alternatingly a first refraction index and a second refraction index, wherein the second refraction index is lower than the first refraction index.

10. The radiation detector (10; 11; 12) according to claim 9 wherein the at least two layers in the stack are a caesium iodide layer and a zinc sulphide layer.

11. The radiation detector (10; 11; 12) according to claim 1 wherein the scintillator (15) is a columnar CsI:Ti scintillator.

12. The radiation detector (10; 11; 12) according to claim 5 wherein the desired wavelength range of the interference optical filter (25) corresponds to a product of a specific emission wavelength band of the scintillator (15) and a specific receiving wavelength band of the photosensor (20).

13. The radiation detector (10; 11; 12) according to claim 12 wherein the desired wavelength range of the interference optical filter (30) is 350-650 nm or 0-650 nm.

14. A flat panel radiation detector comprising the radiation detector (10; 11; 12) according to claim 1.

15. A radiological instrument for radiographic imaging comprising the radiation detector (10; 11; 12) according to claim 1.

16. A method of manufacturing a radiation detector (10), the radiation detector (10) detecting incident radiation (RR) received at a first side (S1) of the radiation detector (10), the method comprising:
constructing an interference optical filter (25),
coupling the interference optical filter (25) to a photosensor (20) at a second side (S2) of the radiation detector (10) opposite to the first side (S1), growing a scintillator layer (15) for converting the incident radiation (RR) received at the first side (S1) into converted radiation (CR),
coupling the scintillator layer (15) to the interference optical filter (25), the photosensor (20) receiving the converted radiation (CR) from the scintillator layer (15), wherein areas of the scintillator layer (15) on which the incident radiation (RR) impinges are intended to be imaged onto corresponding areas of the photosensor (20) and the interference optical filter (25) attenuating a portion of the converted radiation (CR) resulting from the incident radiation (RR) impinging on a particular one (A1) of the areas of the scintillator (15) and received via direct transmission through the interference optical filter (25) by another one (A3) of the areas of the photosensor (20) different from the one (A2) corresponding to the particular one (A1) of the areas of the scintillator (15).

17. A method of detecting incident radiation (RR) received at a first side (S1) of a radiation detector (10), the method comprising
converting the incident radiation (RR) into converted radiation (CR) with a scintillator (15),
receiving the converted radiation (CR) from the scintillator (15) by a photosensor (20) at a second side (S2) of the radiation detector (10) opposite to the first side (S1), wherein areas of the scintillator (15) on which the incident radiation (RR) impinges are intended to be imaged onto corresponding areas of the photosensor (20), and
attenuating with an interference optical filter (25) between the scintillator (15) and the photosensor (20) a portion of the converted radiation (CR) resulting from the incident radiation (RR) impinging on a particular one (A1) of the areas of the scintillator (15) and received through direct transmission through the interference optical filter (25) by another one (A3) of the areas of the photosensor (20) different from the one (A2) corresponding to the particular one (A1) of the areas of the scintillator (15).

18. A radiological instrument for radiographic imaging comprising the flat panel radiation detector according to claim 14.

19. The radiation detector (10; 11; 12) according to claim 2 wherein the desired wavelength range of the interference optical filter (25) corresponds to a product of a specific emission wavelength band of the scintillator (15) and a specific receiving wavelength band of the photosensor (20).

20. The radiation detector (12) according to claim 7 further comprising an optical layer (35) arranged between the scintillator (15) and the interference optical filter (25) or between the interference optical filter (25) and the photosensor (20) for protecting the photosensor (20) against the incident radiation (RR).
